(19) United States
(12) Patent Application Publication
(10) Pub. No.: US 2021/0173648 A1
(43) Pub. Date: Jun. 10, 2021

(54) PROCESSOR FOR NEURAL NETWORK OPERATION

(71) Applicant: National Tsing Hua University, Hsinchu City (TW)

(72) Inventors: Yun-Chen LO, Hsinchu City (TW); Yu-Chun KUO, Hsinchu City (TW); Yun-Sheng CHANG, Hsinchu City (TW); Jian-Hao HUANG, Hsinchu City (TW); Jun-Shen WU, Hsinchu City (TW); Wen-Chien TING, Hsinchu City (TW); Tai-Hsing WEN, Hsinchu City (TW); Ren-Shuo LIU, Hsinchu City (TW)

(73) Assignee: National Tsing Hua University, Hsinchu City (TW)

(21) Appl. No.: 17/108,470

(22) Filed: Dec. 1, 2020

Related U.S. Application Data
(60) Provisional application No. 62/943,820, filed on Dec. 5, 2019.

(51) Int. Cl. G06F 9/30; G06N 3/08; G06N 3/063; G06F 9/38; G06F 9/54

(52) U.S. Cl. CPC G06F 9/30047; G06N 3/08; G06F 9/544; G06F 9/3869; G06F 9/30105; G06N 3/063

(57) ABSTRACT

A processor adapted for neural network operation is provided to include a scratchpad memory, a processor core, a neural network accelerator coupled to the processor core, and a arbitration unit coupled to the scratchpad memory, the processor core and the neural network accelerator. The processor core and the neural network accelerator share the scratchpad memory via the arbitration unit.

### CROSS-REFERENCE TO RELATED APPLICATION

This application claims priority of U.S. Provisional Patent Application No. 62/943,820, filed on Dec. 5, 2019.

### FIELD

The disclosure relates to a neural network, and more particularly to an architecture of a processor adapted for neural network operation.

### BACKGROUND

Convolutional neural networks (CNNs) have recently emerged as a means to tackle artificial intelligence (AI) problems such as computer vision. State-of-the-art CNNs can recognize one thousand categories of objects in the ImageNet dataset both faster and more accurately than humans.

Among the CNN techniques, binary CNNs (BNNs for short) are suitable for embedded devices such as those for the Internet of things (IoT). The multiplications of BNNs are equivalent to logic XNOR operations, which are much simpler and consume much lower power than full-precision integer or floating-point multiplications. Meanwhile, open-source hardware and open standard instruction set architecture (ISA) have also attracted great attention. For example, RISC-V solutions have become available and popular in recent years.

In view of the BNN, IoT, and RISC-V trends, some architectures that integrate embedded processors with BNN acceleration have been developed, such as the vector processor (VP) architecture and the peripheral engine (PE) architecture, as illustrated in FIG. 1.

In the VP architecture, the BNN acceleration is tightly coupled to processor cores. More specifically, the VP architecture integrates vector instructions into the processor cores, and thus offers good programmability to support general-purpose workloads. However, such architecture is disadvantageous in that it involves significant costs for developing toolchains (e.g., compilers) and hardware (e.g., pipeline datapath and control), and the vector instructions may incur additional power and performance costs from, for example, moving data between static random access memory (SRAM) and processor registers (e.g., load and store) and loops (e.g., branch).

On the other hand, the PE architecture makes the BNN acceleration loosely coupled to the processor cores using a system bus such as the advanced high-performance bus (AHB). In contrast to the VP architecture, most IC design companies are familiar with the PE architecture, which avoids the abovementioned compiler and pipeline development costs. In addition, without loading, storing, and loop costs, the PE architecture can potentially achieve better performance than the VP architecture. The PE architecture is disadvantageous in utilizing private SRAM instead of sharing the available SRAM of the embedded processor cores. Typically, embedded processor cores for IoT devices are equipped with approximately 64 to 160 KB of tightly coupled memory (TCM) that is made of SRAM and that can support concurrent code executions and data transfers. TCM is also known as tightly integrated memory, scratchpad memory, or local memory.

### SUMMARY

Therefore, an object of the disclosure is to provide a processor adapted for neural network operation. The processor can have the advantages of both of the conventional VP architecture and the conventional PE architecture.

According to the disclosure, the processor includes a scratchpad memory, a processor core, a neural network accelerator and an arbitration unit (such as a multiplexer unit). The scratchpad memory is configured to store to-be-processed data, and multiple kernel maps of a neural network model, and has a memory interface. The processor core is configured to issue core-side read/write instructions (such as load and store instructions) that conform with the memory interface to access the scratchpad memory. The neural network accelerator is electrically coupled to the processor core and the scratchpad memory, and is configured to issue accelerator-side read/write instructions that conform with the memory interface to access the scratchpad memory for acquiring the to-be-processed data and the kernel maps from the scratchpad memory to perform a neural network operation on the to-be-processed data based on the kernel maps. The accelerator-side read/write instructions conform with the memory interface. The arbitration unit is electrically coupled to the processor core, the neural network accelerator and the scratchpad memory to permit one of the processor core and the neural network accelerator to access the scratchpad memory.

Another object of the disclosure is to provide a neural network accelerator for use in a processor of this disclosure. The processor includes a scratchpad memory storing to-be-processed data and storing multiple kernel maps of a convolutional neural network (CNN) model.

According to the disclosure, the neural network accelerator includes an operation circuit, a partial-sum memory, and a scheduler. The operation circuit is to be electrically coupled to the scratchpad memory. The partial-sum memory is electrically coupled to the operation circuit. The scheduler is electrically coupled to the partial-sum memory, and is to be electrically coupled to the scratchpad memory. When the neural network accelerator performs a convolution operation for an n^{th} (n is a positive integer) layer of the CNN model, the to-be-processed data is n^{th}-layer input data, and the following actions are performed: (1) the operation circuit receives, from the scratchpad memory, the to-be-processed data and n^{th}-layer kernel maps which are those of the kernel maps that correspond to the n^{th} layer, and performs, for each of the n^{th}-layer kernel maps, multiple dot product operations of the convolution operation on the to-be-processed data and the n^{th}-layer kernel map; (2) the partial-sum memory is controlled by the scheduler to store intermediate calculation results that are generated by the operation circuit during the dot product operations; and (3) the scheduler controls data transfer between the scratchpad memory and the operation circuit and data transfer between the operation circuit and the partial-sum memory in such a way that the operation circuit performs the convolution operation on the to-be-processed data and the n^{th}-layer kernel maps so as to generate multiple n^{th}-layer output feature maps that respectively correspond to the n^{th}-layer kernel maps, after which the operation circuit provides the n^{th}-layer output feature maps to the scratchpad memory for storage therein.

Yet another object is to provide a scheduler circuit for use in a neural network accelerator of this disclosure. The neural network accelerator is electrically coupled to a scratchpad memory of a processor. The scratchpad memory stores to-be-processed data, and multiple kernel maps of a convolutional neural network (CNN) model. The neural network accelerator is configured to acquire the to-be-processed data and the kernel maps from the scratchpad memory so as to perform a neural network operation on the to-be-processed data based on the kernel maps.

According to the disclosure, the scheduler includes multiple counters, each of which includes a register to store a counter value, a reset input terminal, a reset output terminal, a carry-in terminal, and a carry-out terminal. The counter values stored in the registers of the counters are related to memory addresses of the scratchpad memory where the to-be-processed data and the kernel maps are stored. Each of the counters is configured to, upon receipt of an input trigger at the reset input terminal thereof, set the counter value to an initial value, set an output signal at the carry-out terminal to a disabling state, and generate an output trigger at the reset output terminal. Each of the counters is configured to increment the counter value when an input signal at the carry-in terminal is in an enabling state. Each of the counters is configured to set the output signal at the carry-out terminal to the enabling state when the counter value has reached a predetermined upper limit. Each of the counters is configured to stop incrementing the counter value when the input signal at the carry-in terminal is in the disabling state. Each of the counters is configured to generate the output trigger at the reset output terminal when the counter value has incremented to be overflowing from the predetermined upper limit to become the initial value. The counters have a tree-structured connection in terms of connections among the reset input terminals and the reset output terminals of the counters, wherein, for any two of the counters that have a parent-child relationship in the tree-structured connection, the reset output terminal of one of the counters that serves as a parent node is electrically coupled to the reset input terminal of the other one of the counters that serves as a child node. The counters have a chain-structured connection in terms of connections among the carry-in terminals and the carry-out terminals of the counters, and the chain-structured connection is a post-order traversal of the tree-structured connection, wherein, for any two of the counters that are coupled together in series in the chain-structured connection, the carry-out terminal of one of the counters is electrically coupled to the carry-in terminal of the other one of the counters.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating a conventional VP architecture and a conventional PE architecture for a processor adapted for neural network operation;

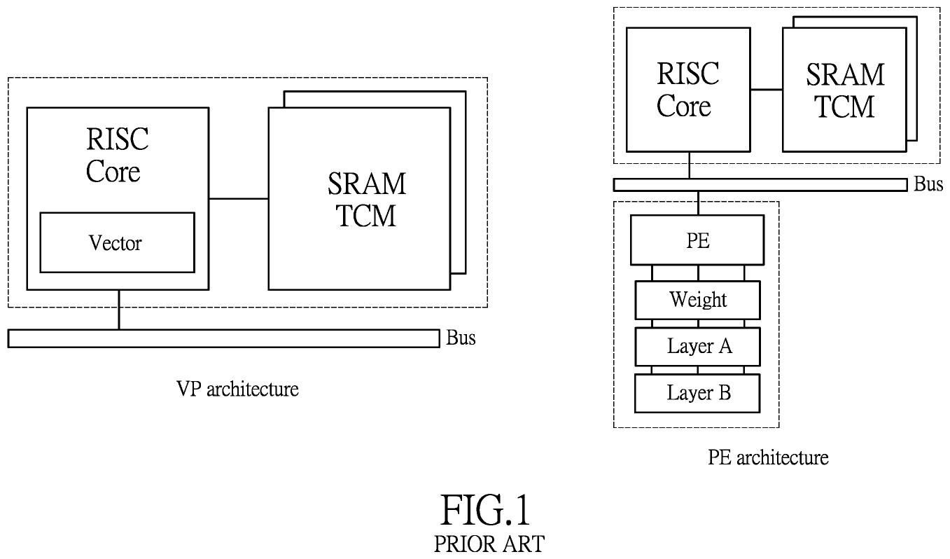

FIG. 2 is a block diagram illustrating an embodiment of a processor adapted for neural network operation according to this disclosure.

FIG. 3 is a schematic circuit diagram illustrating an operation circuit of the embodiment;

FIG. 4 is a schematic diagram exemplarily illustrating operation of an operation circuit of the embodiment;

FIG. 5 is a circuit schematic diagram illustrating a variation of the operation circuit;

FIG. 6 is a schematic diagram exemplarily illustrating operation of the variation of the operation circuit of the embodiment;

FIG. 7 is a schematic diagram illustrating use of an input pointer, a kernel pointer and an output pointer in the embodiment;

FIG. 8 is a pseudo code illustrating operation of a scheduler of the embodiment;

FIG. 9 is a block diagram illustrating an exemplary implementation of the scheduler;

FIG. 10 is a schematic circuit diagram illustrating a conventional circuit that performs max pooling, batch normalization and binarization; and

FIG. 11 is a schematic circuit diagram illustrating a feature processing circuit of the embodiment that fuses max pooling, batch normalization and binarization.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

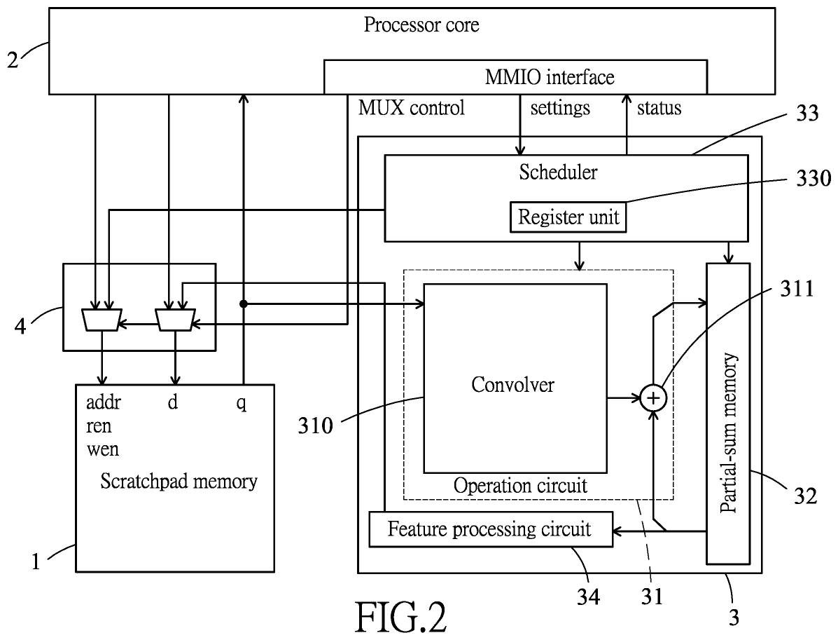

Referring to FIG. 2, an embodiment of a processor adapted for neural network operation according to this disclosure is shown to include a scratchpad memory 1, a processor core 2, a neural network accelerator 3 and an arbitration unit 4. The processor is adapted to perform a neural network operation based on a neural network model that has multiple layers, each of which corresponds to multiple kernel maps. Each of the kernel maps is composed of a plurality of kernel weights. The kernel maps that correspond to the n^{th} one of the layers (referred to as the n^{th} layer hereinafter) are referred to as the n^{th}-layer kernel maps hereinafter, where n is a positive integer.

The scratchpad memory 1 may be static random-access memory (SRAM), magnetoresistive random-access memory (MRAM), or other types of non-volatile random-access memory, and has a memory interface. In this embodiment, the scratchpad memory 1 is realized using SRAM that has an SRAM interface (e.g., a specific format of a read enable (ren) signal, a write enable (wen) signal, input data (d), output data (q), and memory address data (addr), etc.), and is configured to store to-be-processed data and the kernel maps of the neural network model. The to-be-processed data may be different for different layers of the neural network model. For example, the to-be-processed data for the first layer could be an input image data, while the to-be-processed data for the n^{th} layer (referred to as the n^{th}-layer input data) may be an (n−1)^{th}-layer output feature map (the output of the (n−1)^{th} layer) in the case of n>1.

The processor core 2 is configured to issue memory address and read/write instructions (referred to as core-side read/write instructions) that conform with the memory interface to access the scratchpad memory 1.

The neural network accelerator 3 is electrically coupled to the processor core 2 and the scratchpad memory 1, and is configured to issue memory address and read/write instructions (referred to as accelerator-side instructions) that conform with the memory interface to access the scratchpad memory 1 for acquiring the to-be-processed data and the kernel maps from the scratchpad memory 1 to perform a neural network operation on the to-be-processed data based on the kernel maps.

In this embodiment, the processor core 2 has a memory-mapped input/output (MMIO) interface to communicate with the neural network accelerator 3. In other embodiments, the processor core 2 may use a port-mapped input/output (PMIO) interface to communicate with the neural network accelerator 3. Since commonly used processor cores usually support MMIO interface and/or PMIO interface, no additional cost is required in developing specialized toolchains (e.g., compilers) and hardware (pipeline datapath and control), which is advantageous in comparison to the conventional VP architecture that uses vector arithmetic instructions to perform required computation.

The arbitration unit 4 is electrically coupled to the processor core 2, the neural network accelerator 3 and the scratchpad memory 1 to permit one of the processor core 2 and the neural network accelerator 3 to access the scratchpad memory 1 (i.e., permitting passage of a read/write instruction, memory address, and/or to-be-stored data that are provided from one of the processor core 2 and the neural network accelerator 3 to the scratchpad memory 1). As a result, the neural network accelerator 3 can share the scratchpad memory with the processor core 2, and thus the processor requires less private memory in comparison to the conventional PE architecture. In this embodiment, the arbitration unit 4 is exemplarily realized as a multiplexer that is controlled by the processor core 2 to select output data, but this disclosure is not limited in this respect.

The abovementioned architecture is applicable to a variety of neural network models including convolutional neural networks (CNNs), recurrent neural networks (RNNs), long-short term memory (LSTM), and so on. In this embodiment, the neural network model is a convolutional neural network (CNN) model, and the neural network accelerator 3 includes an operation circuit 31, a partial-sum memory 32, a scheduler 33 and a feature processing circuit 34.

The operation circuit 31 is electrically coupled to the scratchpad memory 1 and the partial-sum memory 32. When the neural network accelerator 3 performs a convolution operation for the n^{th} layer of the CNN model, the operation circuit 31 receives, from the scratchpad memory 1, the n^{th}-layer input data and n^{th}-layer kernel maps, and performs, for each of the n^{th}-layer kernel maps, multiple dot product operations of the convolution operation on the n^{th}-layer input data and the n^{th}-layer kernel map.

The partial-sum memory 32 may be realized using SRAM, MRAM, or register files, and is controlled by the scheduler 33 to store intermediate calculation results that are generated by the operation circuit 31 during the dot product operations. Each of the intermediate calculation results corresponds to one of the dot product operations, and may be referred to as a partial sum or a partial sum value of a final result of said one of the dot product operations hereinafter. As an example, a dot product of two vectors A=[a₁, a₂, a₃] and B=[b₁, b₂, b₃] is a₁b₁+a₂b₂+a₃b₃, where a₁b₁ may be calculated first and serve as a partial sum of the dot product, then a₂b₂ is calculated and added to the partial sum (which is a₁b₁ at this time) to update the partial sum, and a₃b₃ is calculated and added to the partial sum (which is a₁b₁+a₂b₂ at this time) at last to obtain a total sum (final result) that serves as the dot product.

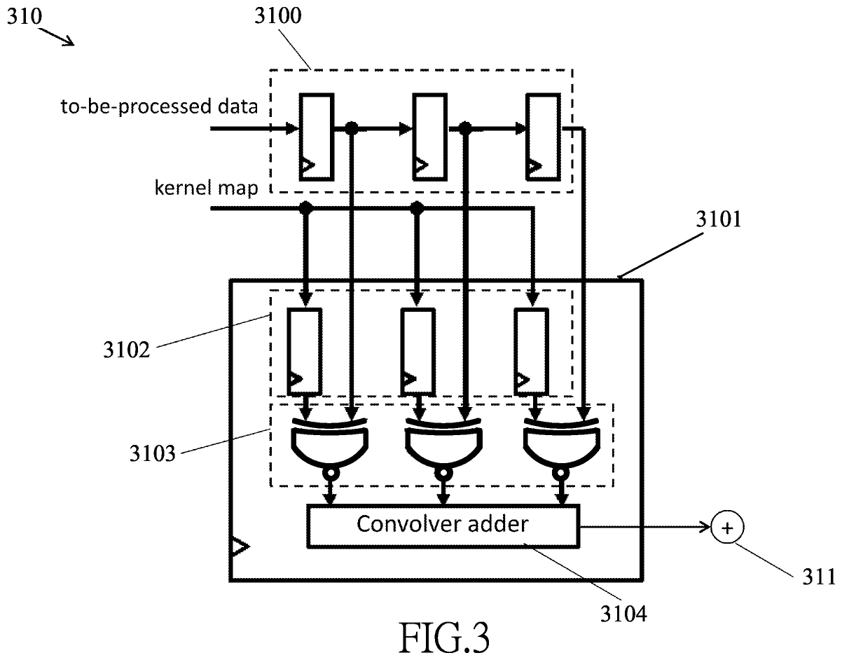

In this embodiment, the operation circuit 31 includes a convolver 310 (a circuit used to perform convolution) and a partial-sum adder 311 to perform the dot product operations for the n^{th}-layer kernel maps, one n^{th}-layer kernel map at a time. Referring to FIG. 3, the convolver 310 includes a first register unit 3100, and a dot product operation unit 3101 that includes a second register unit 3102, a multiplier unit 3103 and a convolver adder 3104. The first register unit 3100 is a shift register unit 3100 and includes a series of registers, and receives the to-be-processed data from the scratchpad memory 1. The second register unit 3102 receives the n^{th}-layer kernel map from the scratchpad memory 1. The multiplier unit 3103 includes a plurality of multipliers each having two multiplier inputs. One of the multiplier inputs is coupled to an output of a respective one of the registers of the shift register unit 3100, and the other one of the multiplier inputs is coupled to an output of a respective one of the registers of the second register unit 3102. The convolver adder 3104 receives the multiplication products outputted by the multipliers of the multiplier unit 3103, and generates a sum of the multiplication products, which is provided to the partial-sum adder 311.

In this embodiment, the CNN model is exemplified as a binary CNN (BNN for short) model, so each of the multipliers of the multiplier unit 3103 can be realized as an XNOR gate, and the convolver adder 3104 can be realized as a population count (popcount) circuit.

The partial-sum adder 311 is electrically coupled to the convolver adder 3104 for receiving a first input value, which is the sum that corresponds to a dot operation and that is outputted by the convolver adder 3104, is electrically coupled to the partial-sum memory 32 for receiving a second input value, which is one of the intermediate calculation results that corresponds to the dot operation, and adds up the first input value and the second input value to generate an updated intermediate calculation result which is to be stored back into the partial-sum memory 32 to update said one of the intermediate calculation results.

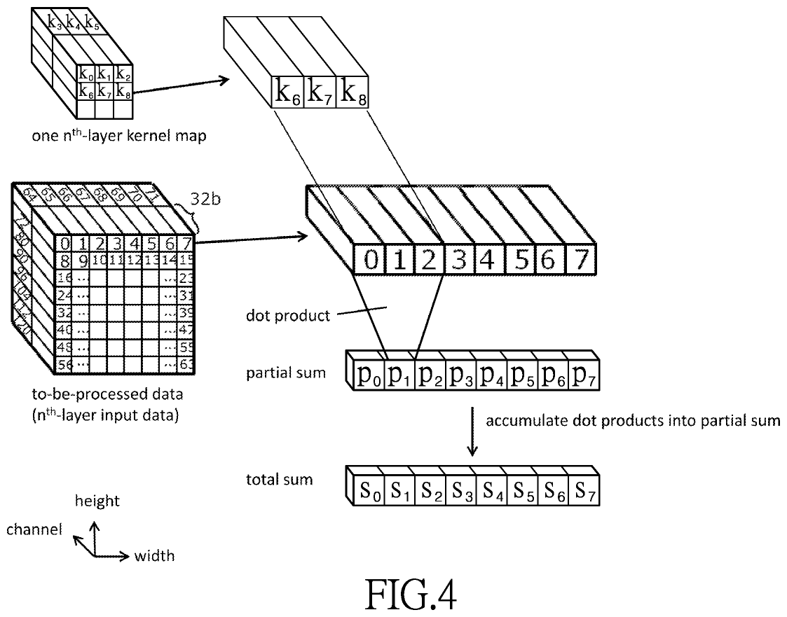

FIG. 4 exemplarily illustrates the operation of the operation circuit 31. In this example, the to-be-processed input data, the kernel map and the output feature map logically have a three-dimensional data structure (e.g., height, width and channel). The kernel map is a 64-channel 3×3 kernel map (3×3×64 kernel weights), the to-be-processed data is 64-channel 8×8 data (8×8×64 input data values), each of the registers of the shift register unit 3100 and the second register unit 3102 has 32 channels, and each XNOR symbol in FIG. 3 represents 32 XNOR gates that respectively correspond to the 32 channels of the corresponding register of each of the shift register unit 3100 and the second register unit 3102. During the convolution operation, only a part of the kernel map (e.g., 32-channel 3×1 of data of the kernel map, which is exemplified to include the 32-channel data groups denoted by “k₆”, “k₇”, “k₈” in FIG. 4) and a part of the to-be-processed data (e.g., 32-channel 3×1 of data of the to-be-processed data, which is exemplified to include the 32-channel data groups numbered “0”, “1”, “2” in FIG. 4) are used in the dot product operation at a time, according to the number of multipliers and registers. It is noted that a zero-padding technique may be used in the convolution operation, so that the width and the height of the convolution result are the same as the width and the height of the to-be-processed input data. The shift register unit 3100 causes the dot product operation to be performed on the part of the kernel map and different parts of the to-be-processed data, one part of the to-be-processed data at a time. In other words, the different parts of the to-be-processed data take turns in being a second input to the dot product operation with the part of the kernel map serving as a first input to the dot product operation. For instance, in the first round, the dot product operation is performed on the part of the kernel map (the data groups “k₆”, “k₇”, and “k₈” in FIG. 4) and a first part of the to-be-processed data (e.g., a data group of zeros generated by zero-padding plus the data groups “0” and “1” in FIG. 4) to generate a dot product to be added to a partial-sum value “p₀” (which is adjusted bias, by default, which will be presented shortly) by the partial-sum adder 311. In the second round, the dot product operation is performed on the part of the kernel map (the data groups “k₆”, “k₇”, and “k₈” in FIG. 4) and a second part of the to-be-processed data (e.g., the data groups “0”, “1” and “2” in FIG. 4) to generate a dot product to be added to a partial-sum value “p₁” (which is zero by default) by the partial-sum adder 311. In the third round, the dot product operation is performed on the part of the kernel map (the data groups “k₆”, “k₇”, and “k₈” in FIG. 4) and a third part of the to-be-processed data (e.g., the data groups “1”, “2”, and “3” in FIG. 4) to generate a dot product to be added to a partial-sum value “p₂” (which is zero by default) by the partial-sum adder 311. Such operation may be performed for a total of eight rounds so the partial-sum data values “p₀” to “p₇” can be obtained. Note that in the example depicted in FIG. 4, zero-padding may be used in the 8th round to compose the eighth part of the to-be-processed data together with the data groups “6” and “7”. Then, another part of the kernel map may be used to perform the above-mentioned operation with the data groups “0” to “7” to obtain eight dot products respectively to be added to the partial-sum values “p₀” to “p₇”. When the convolution operation of the kernel map and the to-be-processed data is completed, a corresponding 8×8 convolution result (8×8=64 total sums) would be obtained and then provided to the feature processing circuit 34.

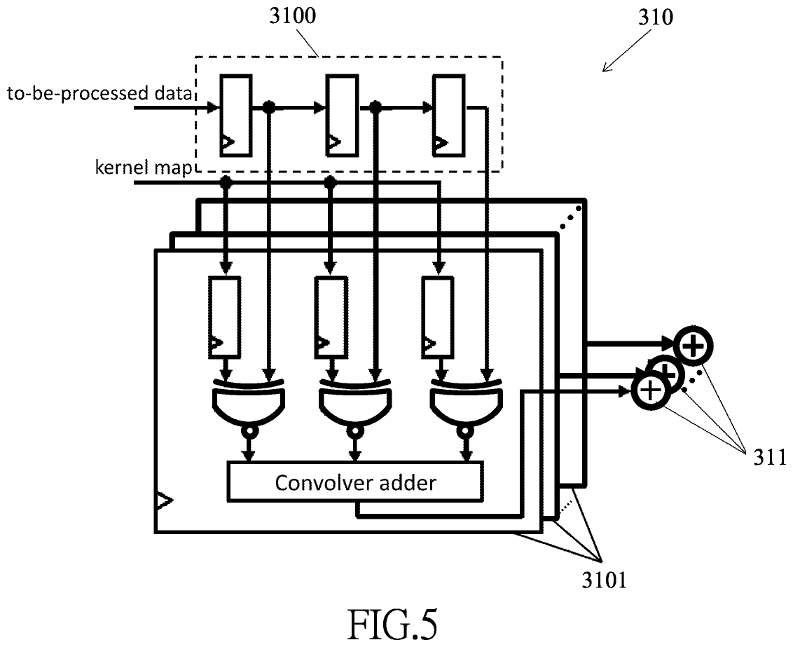

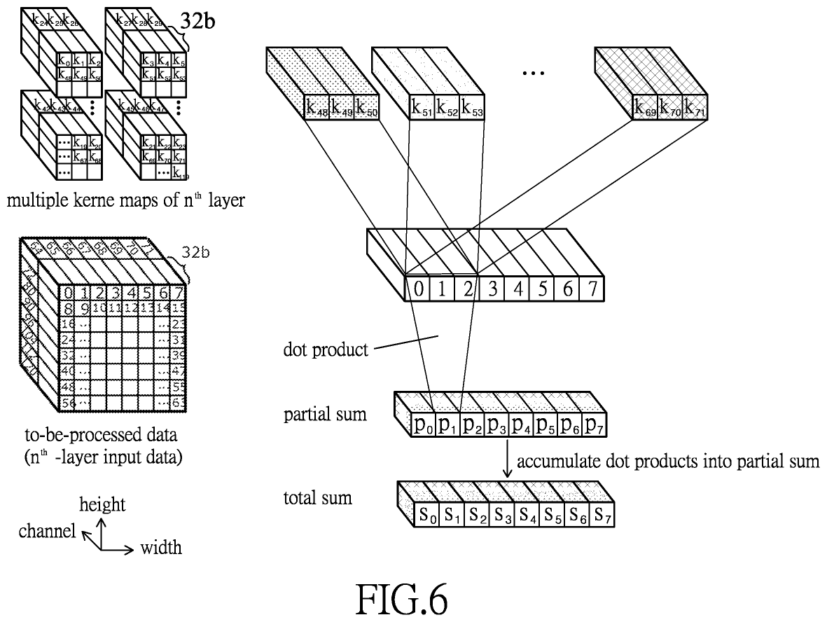

In other embodiments, the convolver 310 may include a plurality of the dot product operation units 3101 that respectively correspond to multiple different kernel maps of the same layer to perform the convolution operation on the to-be-processed data and different ones of the kernel maps at the same time, as exemplarily illustrated in FIG. 5, in which case the operation circuit 31 (see FIG. 2) would also include a plurality of the partial-sum adders 311 to correspond respectively to the dot product operation units 3101, and the operations of the operation circuit 31 are exemplified in FIG. 6. Since the operation for each kernel map is the same as described for FIG. 4, details thereof are omitted herein for the sake of brevity.

The data layout and the computation scheduling exemplified in FIGS. 4 and 6 may increase the numbers of sequential memory accesses and exhaust data reuses of the partial sums, thereby reducing the required capacity for the partial-sum memory 32.

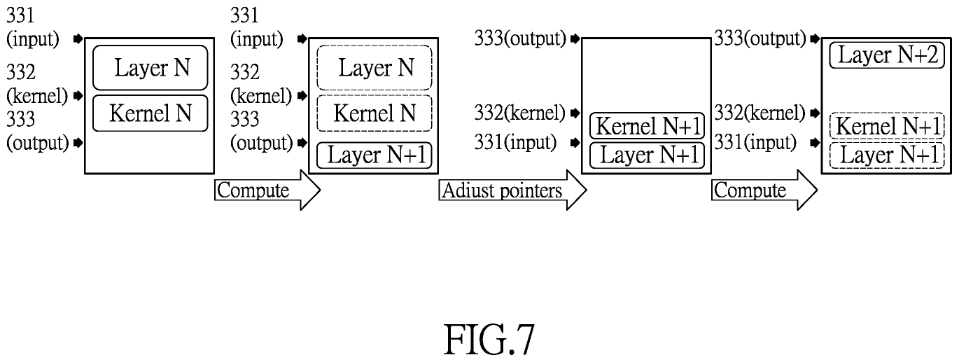

Referring to FIG. 2 again, in this embodiment, the scheduler 33 includes a third register unit 330 that includes multiple registers (not shown) that relate to, for example, pointers of memory addresses, a status (e.g., busy or ready) of the neural network accelerator 3, and settings such as input data width, input data height, and pooling setting, etc. The processor core 2 is electrically coupled to the scheduler 33 for setting the registers of the scheduler 33, for reading the settings of the registers, and/or reading the status of the neural network accelerator 3 (e.g., via the MMIO interface). In this embodiment, the third register unit 330 of the scheduler 33 stores an input pointer 331, a kernel pointer 332, and an output pointer 333, as shown in FIG. 7. The scheduler 33 loads the to-be-processed data from the scratchpad memory 1 based on the input pointer 331, loads the kernel maps from the scratchpad memory 1 based on the kernel pointer 332, and stores a result of the convolution operation into the scratchpad memory 1 based on the output pointer 333.

When the neural network accelerator 3 performs the convolution operation for the n^{th} layer of the neural network model, the input pointer 331 points to a first memory address of the scratchpad memory 1 where the n^{th}-layer input data (denoted as “Layer N” in FIG. 7) is stored, the kernel pointer 332 points to a second memory address of the scratchpad memory 1 where the n^{th}-layer kernel maps (denoted as “Kernel N” in FIG. 7) are stored, and the output pointer 333 points to a third memory address of the scratchpad memory 1 to store the n^{th}-layer output feature maps that are the result of the convolution operation for the n^{th}-layer.

When the neural network accelerator 3 performs the convolution operation for an (n+1)^{th} layer of the neural network model, the input pointer 331 points to the third memory address of the scratchpad memory 1 and makes the n^{th}-layer output feature maps stored therein serve as the to-be-processed data for the (n+1)^{th} layer (denoted as “Layer N+1” in FIG. 7), the kernel pointer 332 points to a fourth memory address of the scratchpad memory 1 where (n+1)^{th}-layer kernel maps (denoted as “Kernel N+1” in FIG. 7) are stored, and the output pointer 333 points to a fifth memory address of the scratchpad memory 1 for storage of a result of the convolution operation for the (n+1)^{th}-layer therein (which serves as the to-be-processed data for the (n+2)^{th} layer, denoted as “Layer N+2” in FIG. 7). It is noted that the fourth memory address may be either the same as or different from the second memory address, and that the fifth memory address may be either the same as or different from the first memory address. By such arrangement, the memory space can be reused for the to-be-processed input data, the output data, and the kernel maps of different layers, thereby minimizing the required memory capacity.

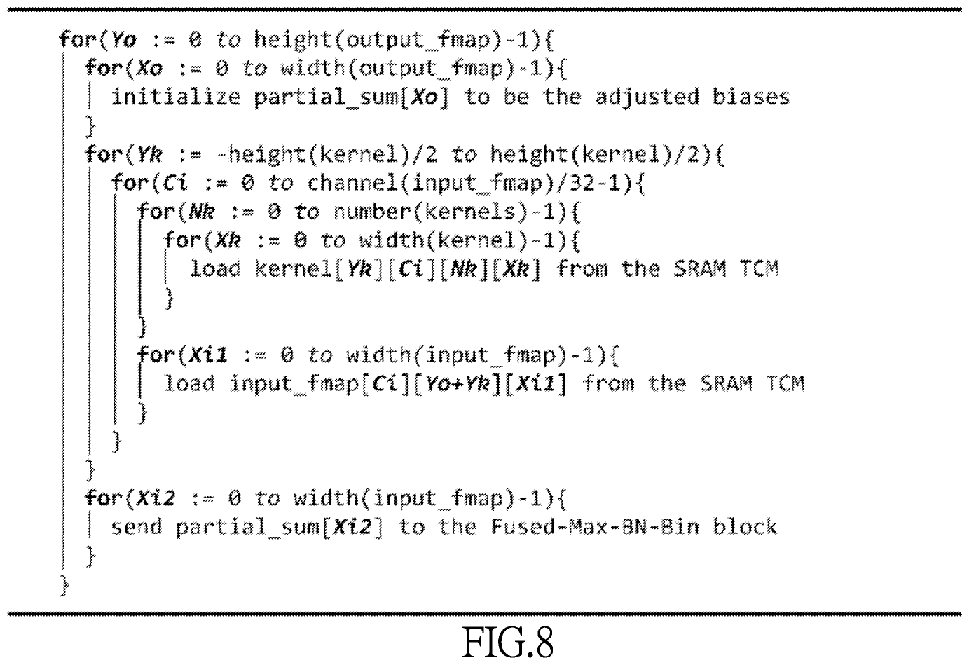

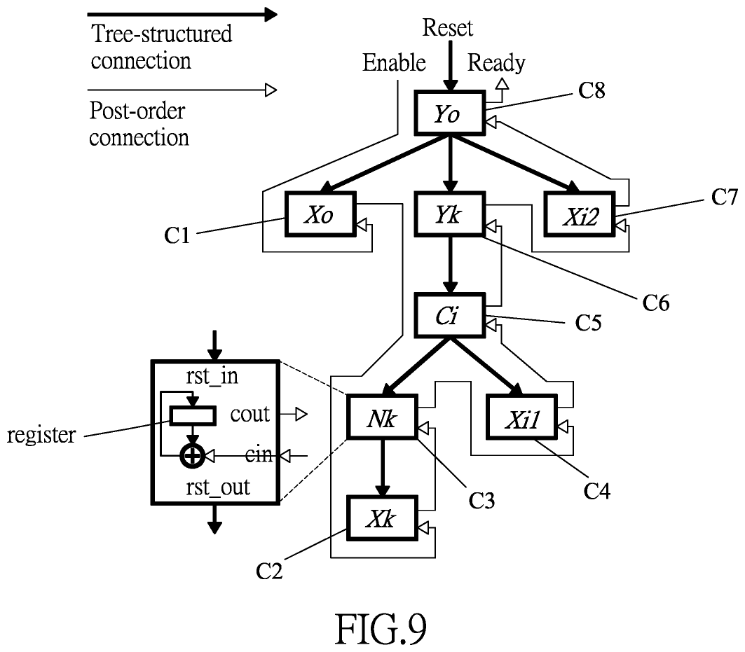

Furthermore, the scheduler 33 is electrically coupled to the arbitration unit 4 for accessing the scratchpad memory 1 therethrough, is electrically coupled to the partial-sum memory 32 for accessing the partial-sum memory 32, and is electrically coupled to the convolver 310 for controlling the timing of updating data that is stored in the register unit 3100. When the neural network accelerator 3 performs a convolution operation for the n^{th} layer of the neural network model, the scheduler 33 controls data transfer between the scratchpad memory 1 and the operation circuit 31 and data transfer between the operation circuit 31 and the partial-sum memory 32 in such a way that the operation circuit 31 performs the convolution operation on the to-be-processed data and each of the n^{th}-layer kernel maps so as to generate multiple n^{th}-layer output feature maps that respectively correspond to the n^{th}-layer kernel maps, after which the operation circuit 31 provides the n^{th}-layer output feature maps to the scratchpad memory 1 for storage therein. In detail, the scheduler 33 fetches the to-be-processed data and the kernel weights from the scratchpad memory 1, sends the same to the registers of the operation circuit 31 for performing bitwise dot products (e.g., XNOR, popcount, etc.) and accumulating the dot product results in the partial-sum memory 32. Particularly, the scheduler 33 of this embodiment schedules the operation circuit 31 to perform the convolution operation in a manner as exemplified in either FIG. 4 or FIG. 6. As shown in FIG. 8, an exemplary pseudo code that describes the operation of the scheduler 33 is depicted, and FIG. 9 illustrates a circuit block structure that corresponds to the pseudo code depicted in FIG. 8 and that is realized using a plurality of counters C1-C8.

Each of the counters C1 to C8 includes a register to store a counter value, a reset input terminal (rst_in), a reset output terminal (rst_out), a carry-in terminal (cin), and a carry-out terminal (cout). The counter values stored in the registers of the counters C1-C8 are related to memory addresses of the scratchpad memory 1 where the to-be-processed data and the kernel maps are stored. Each of the counters C1-C8 is configured to perform the following actions: 1) upon receipt of an input trigger at the reset input terminal thereof, setting the counter value to an initial value (e.g., zero), setting an output signal at the control output terminal to a disabling state (e.g., logic low), and generating an output trigger at the reset output terminal; 2) when an input signal at the carry-in terminal is in an enabling state (e.g., logic high), incrementing the counter value (e.g., adding one to the counter value); 3) when the counter value has reached a predetermined upper limit, setting the output signal at the carry-out terminal to the enabling state; 4) when the input signal at the carry-in terminal is in the disabling state, stopping incrementing on the counter value; and 5) generating the output trigger at the reset output terminal when the counter value has incremented to be overflowing from the predetermined upper limit to become the initial value. It is noted that the processor core 2 may, via the MMIO interface, set the predetermined upper limit of the counter value, inform the scheduler 33 to start counting, check the progress of the counting, and prepare the next convolution operation (e.g., updating the input, kernel and output pointers 331, 332, 333, changing the predetermined upper limits for the counters if needed, etc.) when the counting is completed (i.e., the current convolution operation is finished). In this embodiment, the counter values of the counters C1-C8 respectively represent a position (Xo) of the output feature map in a width direction of the data structure, a position (Xk) of the kernel map (denoted as “kernel” in FIG. 8) in the width direction of the data structure, a ordinal number (Nk) of the kernel map (one layer has multiple kernel maps, which are numbered herein), a first position (Xi1) of the to-be-processed input data (denoted as “input_fmap” in FIG. 8) in the width direction of the data structure, a position (Ci) of the to-be-processed input data in a channel direction of the data structure, a position (Yk) of the kernel map in a height direction of the data structure, a second position (Xi2) of the to-be-processed input data in the width direction of the data structure, and a position (Yo) of the output feature map (denoted as “output_fmap” in FIG. 8) in the height direction of the data structure.

The counters C1-C8 have a tree-structured connection in terms of connections among the reset input terminals and the reset output terminals of the counters C1-C8. That is, for any two of the counters C1-C8 that have a parent-child relationship in the tree-structured connection, the reset output terminal of one of the two counters that serves as a parent node is electrically coupled to the reset input terminal of the other one of the two counters that serves as a child node. As illustrated in FIG. 9, the tree-structured connection of the counters C1-C8 in this embodiment has the following parent-child relationships: the counter C8 serves as a parent node in a parent-child relationship with each of the counters C1, C6 and C7 (i.e., the counters C1, C6 and C7 are children to the counter C8); the counter C6 serves as a parent node in a parent-child relationship with the counter C5 (i.e., the counter C5 is a child to the counter C6); the counter C5 serves as a parent node in a parent-child relationship with each of the counters C3 and C4 (i.e., the counters C3 and C4 are children to the counter C5); and the counter C3 serves as a parent node in a parent-child relationship with the counter C2 (i.e., the counter C2 is a child to the counter C3).

On the other hand, the counters C1-C8 have a chain-structured connection in terms of connections among the carry-in terminals and the carry-out terminals of the counters C1-C8, and the chain-structured connection is a post-order traversal of the tree-structured connection, wherein, for any two of the counters C1-C8 that are coupled together in series in the chain-structured connection, the carry-out terminal of one of the two counters is electrically coupled to the carry-in terminal of the other one of the two counters. As illustrated in FIG. 9, the counters C1-C8 of this embodiment are coupled one by one in the given order in the chain-structured connection. It is noted that the implementation of the scheduler 33 is not limited to what is disclosed herein.

After the convolution of the to-be-processed data and one of the kernel maps is completed, usually the convolution result would undergo max pooling (optional in some layers), batch normalization and quantization. For the purpose of explanation, the quantization is exemplified as binarization since the exemplary neural network model is a BNN model. The max pooling, the batch normalization and the binarization can together be represented using a logic operation of:

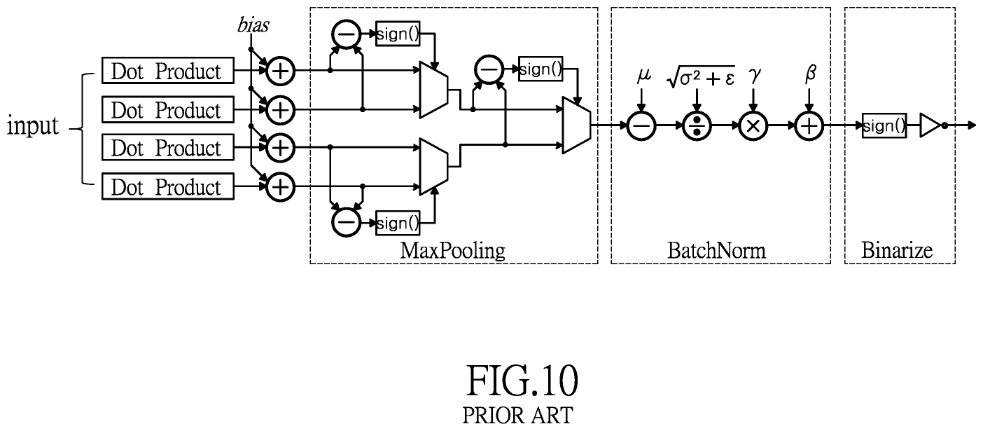

y=NOT{sign((Max(xᵢ−b₀)−μ)÷\sqrt{σ²−ε}×γ−β)} (1)

where xᵢ represents inputs of the operation of the max pooling, the batch normalization and the binarization combined, which are results of the dot product operations of the convolution operation; y represents a result of the operation of the max pooling, the batch normalization and the binarization combined; b₀ represents a predetermined bias; μ represents an estimated average of the results of the dot product operations of the convolution operation that is obtained during the training of the neural network model; σ represents an estimated standard deviation of the results of the dot product operations of the convolution operation that is obtained during the training of the neural network model; ε represents a small constant to avoid dividing by zero; γ represents a predetermined scaling factor; and β represents an offset. FIG. 10 illustrates a conventional circuit structure to realize equation (1) in a case that a number of inputs is four. The conventional circuit structure involves four addition operations for adding a bias to the four inputs, seven integer operations (1 adder, 4 subtractors, 1 multiplier, and 1 divider) and three integer multiplexers for max pooling and batch normalization, and four binarization circuits for binarization, so as to produce one output for the four inputs.

This embodiment proposes using a simpler circuit structure on the feature processing circuit 34 to achieve the same function as the conventional circuit structure. The feature processing circuit 34 is configured to perform a fused operation of max pooling, batch normalization and binarization on a result of the convolution operation performed on the to-be-processed data and the n^{th}-layer kernel maps, so as to generate the n^{th}-layer output feature maps. The fused operation can be derived from equation (1) to be:

$$y = {AND}_{i} ( sign ( {x}_{i} + {b}_{a} ) ) XNOR sign ( γ ) \\ where sign ( x ) = \{ \begin{matrix}0 if x \geq 0 \\ 1 if x < 0\end{matrix} \qquad ( 2 )$$

where xᵢ represents inputs of the fused operation, which are results of the dot product operations of the convolution operation; y represents a result of the fused operation; γ represents a predetermined scaling factor, and bₐ represents an adjusted bias related to an estimated average and an estimated standard deviation of the results of the dot product operations of the convolution operation. In detail,

$${b}_{a} = {b}_{c} - ( \frac{β \cdot \sqrt{{σ}^{2 ⊥} ɛ}}{γ} - μ )$$

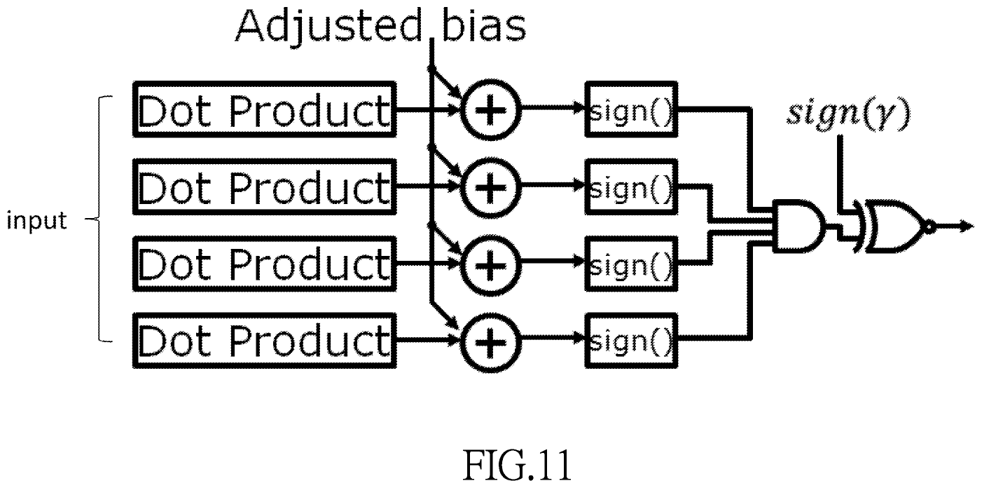

The feature processing circuit 34 includes a number i of adders for adding the adjusted bias to the inputs, a number i of binarization circuits, an i-input AND gate and a two-input XNOR gate that are coupled together to perform the fused operation. In this embodiment, the binarization circuits perform binarization by obtaining only the most significant bit of data inputted thereto, but this disclosure is not limited to such. FIG. 11 illustrates an exemplary implementation of the feature processing circuit 34 in a case that the number i of inputs is four, where the blocks marked “sign( )” represent the binarization circuits. In comparison to FIG. 10, the hardware required for max pooling, batch normalization and binarization is significantly reduced by using the feature processing circuit 34 of this embodiment. Note that the adjusted bias bₐ is a predetermined value that is calculated off-line, so no cost will be incurred at the run time.

In summary, the embodiment of the processor of this disclosure uses an arbitration unit 4 so that the processor core 2 and the neural network accelerator 3 can share the scratchpad memory 1, and further uses a generic I/O interface (e.g., MMIO, PMIO, etc.) to communicate with the neural network accelerator 3, so as to reduce the cost for developing specialized toolchains and hardware. Therefore, the embodiment of the processor have the advantages of both of the conventional VP architecture and the conventional PE architecture. The proposed data layout and computation scheduling may help minimize the require capacity of the partial-sum memory by exhausting the reuses of the partial sums. The proposed structure of the feature processing circuit 34 fuses the max pooling, the batch normalization and the binarization, thereby reducing the required hardware resource.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A processor adapted for neural network operation, comprising:
a scratchpad memory that is configured to store to-be-processed data, and multiple kernel maps of a neural network model, and that has a memory interface;
a processor core that is configured to issue core-side read/write instructions that conform with said memory interface to access said scratchpad memory;
a neural network accelerator that is electrically coupled to said processor core and said scratchpad memory, and that is configured to issue accelerator-side read/write instructions that conform with said memory interface to access said scratchpad memory for acquiring the to-be-processed data and the kernel maps from said scratchpad memory so as to perform a neural network operation on the to-be-processed data based on the kernel maps, wherein the accelerator-side read/write instructions conform with said memory interface; and
an arbitration unit that is electrically coupled to said processor core, said neural network accelerator and said scratchpad memory to permit one of said processor core and said neural network accelerator to access said scratchpad memory.

2. The processor of claim 1, wherein the neural network model is a convolutional neural network (CNN) model, and said neural network accelerator includes an operation circuit electrically coupled to said scratchpad memory; a partial-sum memory electrically coupled to said operation circuit; and a scheduler electrically coupled to said processor core, said scratchpad memory and said partial-sum memory;
wherein, when said neural network accelerator performs a convolution operation for an n^{th} layer of the CNN model, where n is a positive integer,
the to-be-processed data is n^{th}-layer input data,
said operation circuit receives, from said scratchpad memory, the to-be-processed data and n^{th}-layer kernel maps which are those of the kernel maps that correspond to the n^{th} layer, and performs, for each of the n^{th}-layer kernel maps, multiple dot product operations of the convolution operation on the to-be-processed data and the n^{th}-layer kernel map,
said partial-sum memory is controlled by said scheduler to store intermediate calculation results that are generated by said operation circuit during the dot product operations, and
said scheduler controls data transfer between said scratchpad memory and said operation circuit and data transfer between said operation circuit and said partial-sum memory in such a way that said operation circuit performs the convolution operation on the to-be-processed data and the n^{th}-layer kernel maps so as to generate multiple n^{th}-layer output feature maps that respectively correspond to the n^{th}-layer kernel maps, after which said operation circuit provides the n^{th}-layer output feature maps to said scratchpad memory for storage therein.

3. The processor of claim 2, wherein said scheduler includes multiple counters, each of which includes a register to store a counter value, a reset input terminal, a reset output terminal, a carry-in terminal, and a carry-out terminal;
wherein the counter values stored in said registers of said counters are related to memory addresses of said scratchpad memory where the to-be-processed data and the kernel maps are stored;
wherein each of said counters is configured to, upon receipt of an input trigger at said reset input terminal thereof, set the counter value to an initial value, set an output signal at said carry-out terminal to a disabling state, and generate an output trigger at said reset output terminal;
wherein each of said counters is configured to increment the counter value when an input signal at said carry-in terminal is in an enabling state;
wherein each of said counters is configured to set the output signal at said carry-out terminal to the enabling state when the counter value has reached a predetermined upper limit;
wherein each of said counters is configured to stop incrementing the counter value when the input signal at said carry-in terminal is in the disabling state;
wherein each of said counters is configured to generate the output trigger at said reset output terminal when the counter value has incremented to be overflowing from the predetermined upper limit to become the initial value;
wherein said counters have a tree-structured connection in terms of connections among said reset input terminals and said reset output terminals of said counters, wherein, for any two of said counters that have a parent-child relationship in the tree-structured connection, said reset output terminal of one of said counters that serves as a parent node is electrically coupled to said reset input terminal of the other one of said counters that serves as a child node; and
wherein said counters have a chain-structured connection in terms of connections among said carry-in terminals and said carry-out terminals of said counters, and the chain-structured connection is a post-order traversal of the tree-structured connection, wherein, for any two of said counters that are coupled together in series in the chain-structured connection, said carry-out terminal of one of said counters is electrically coupled to said carry-in terminal of the other one of said counters.

4. The neural network of claim 2, wherein said scheduler further includes a pointer register unit that stores an input pointer, an output pointer and a kernel pointer, and said scheduler loads the to-be-processed data from said scratchpad memory based on said input pointer, loads the kernel maps from said scratchpad memory based on said kernel pointer, and stores a result of the convolution operation into said scratchpad memory based on said output pointer;
wherein, when said neural network accelerator performs the convolution operation for the n^{th} layer, said input pointer points to a first memory address of said scratchpad memory where the n^{th}-layer input data is stored, said kernel pointer points to a second memory address of said scratchpad memory where the n^{th}-layer kernel maps are stored, and said output pointer points to a third memory address of said scratchpad memory to store the n^{th}-layer output feature maps that are the result of the convolution operation for the n^{th}-layer;
wherein, when said neural network accelerator performs the convolution operation for an (n+1)^{th} layer of the neural network model, said input pointer points to the third memory address of said scratchpad memory and makes the n^{th}-layer output feature maps stored therein serve as the to-be-processed data for the (n+1)^{th} layer, said kernel pointer points to a fourth memory address of said scratchpad memory where (n+1)^{th}-layer kernel maps which are those of the kernel maps that correspond to the (n+1)^{th} layer are stored, and said output pointer points to a fifth memory address of said scratchpad memory for storage of a result of the convolution operation for the (n+1)^{th}-layer therein.

5. The neural network of claim 2, wherein the CNN model is a binary CNN (BNN) model, and said neural network accelerator further includes a feature processing circuit that is configured to perform a fused operation of max pooling, batch normalization and binarization on a result of the convolution operation performed on the to-be-processed data and the n^{th}-layer kernel maps, so as to generate the n^{th}-layer output feature maps, wherein said feature processing circuit includes a number i of adders, a number i of binarization circuits, an i-input AND gate and a two-input XNOR gate that are coupled to perform the fused operation defined by:
$$y = {AND}_{i} ( sign ( {x}_{i} + {b}_{a} ) ) XNOR sign ( γ )$$
$$where sign ( x ) = \{ \begin{matrix}0 if x \geq 0 \\ 1 if x < 0\end{matrix}$$
where xᵢ represents inputs of the fused operation, which are results of the dot product operations of the convolution operation; y represents a result of the fused operation; γ represents a predetermined scaling factor, and bₐ represents a predetermined bias constant related to an estimated average and an estimated standard deviation of the results of the dot product operations of the convolution operation.

6. The processor of claim 2, wherein said processor core has one of a memory-mapped input/output (MMIO) interface and a port-mapped input/output (PMIO) interface to communicate with said neural network accelerator.

7. A neural network accelerator for use in a processor that includes a scratchpad memory storing to-be-processed data and storing multiple kernel maps of a convolutional neural network (CNN) model;
said neural network accelerator comprising:
an operation circuit to be electrically coupled to the scratchpad memory;
a partial-sum memory electrically coupled to said operation circuit; and
a scheduler electrically coupled to said partial-sum memory, and to be electrically coupled to the scratchpad memory;
wherein, when said neural network accelerator performs a convolution operation for an n^{th} layer of the CNN model, where n is a positive integer,
the to-be-processed data is n^{th}-layer input data,
said operation circuit receives, from the scratchpad memory, the to-be-processed data and n^{th}-layer kernel maps which are those of the kernel maps that correspond to the n^{th} layer, and performs, for each of the n^{th}-layer kernel maps, multiple dot product operations of the convolution operation on the to-be-processed data and the n^{th}-layer kernel map,
said partial-sum memory is controlled by said scheduler to store intermediate calculation results that are generated by said operation circuit during the dot product operations, and
said scheduler controls data transfer between the scratchpad memory and said operation circuit and data transfer between said operation circuit and said partial-sum memory in such a way that said operation circuit performs the convolution operation on the to-be-processed data and the n^{th}-layer kernel maps so as to generate multiple n^{th}-layer output feature maps that respectively correspond to the n^{th}-layer kernel maps, after which said operation circuit provides the n^{th}-layer output feature maps to the scratchpad memory for storage therein.

8. The neural network accelerator of claim 7, wherein said scheduler includes multiple counters, each of which includes a register to store a counter value, a reset input terminal, a reset output terminal, a carry-in terminal, and a carry-out terminal;
wherein the counter values stored in said registers of said counters are related to memory addresses of the scratchpad memory where the to-be-processed data and the kernel maps are stored;
wherein each of said counters is configured to, upon receipt of an input trigger at said reset input terminal thereof, set the counter value to an initial value, set an output signal at said carry-out terminal to a disabling state, and generate an output trigger at said reset output terminal;
wherein each of said counters is configured to increment the counter value when an input signal at said carry-in terminal is in an enabling state;
wherein each of said counters is configured to set the output signal at said carry-out terminal to the enabling state when the counter value has reached a predetermined upper limit;
wherein each of said counters is configured to stop incrementing the counter value when the input signal at said carry-in terminal is in the disabling state;
wherein each of said counters is configured to generate the output trigger at said reset output terminal when the counter value has incremented to be overflowing from the predetermined upper limit to become the initial value;
wherein said counters have a tree-structured connection in terms of connections among said reset input terminals and said reset output terminals of said counters, wherein, for any two of said counters that have a parent-child relationship in the tree-structured connection, said reset output terminal of one of said counters that serves as a parent node is electrically coupled to said reset input terminal of the other one of said counters that serves as a child node; and
wherein said counters have a chain-structured connection in terms of connections among said carry-in terminals and said carry-out terminals of said counters, and the chain-structured connection is a post-order traversal of the tree-structured connection, wherein, for any two of said counters that are coupled together in series in the chain-structured connection, said carry-out terminal of one of said counters is electrically coupled to said carry-in terminal of the other one of said counters.

9. The neural network accelerator of claim 7, wherein said scheduler further includes a pointer register unit that stores an input pointer, an output pointer and a kernel pointer, and said scheduler loads the to-be-processed data from the scratchpad memory based on said input pointer, loads the kernel maps from the scratchpad memory based on said kernel pointer, and stores a result of the convolution operation into the scratchpad memory based on said output pointer;
wherein, when said neural network accelerator performs the convolution operation for the n^{th} layer, said input pointer points to a first memory address of the scratchpad memory where the n^{th}-layer input data is stored, said kernel pointer points to a second memory address of the scratchpad memory where the n^{th}-layer kernel maps are stored, and said output pointer points to a third memory address of the scratchpad memory to store the n^{th}-layer output feature maps that are the result of the convolution operation for the n^{th}-layer;
wherein, when said neural network accelerator performs the convolution operation for an (n+1)^{th} layer of the CNN model, said input pointer points to the third memory address of the scratchpad memory and makes the n^{th}-layer output feature maps stored therein serve as the to-be-processed data for the (n+1)^{th} layer, said kernel pointer points to a fourth memory address of the scratchpad memory where (n+1)^{th}-layer kernel maps which are those of the kernel maps that correspond to the (n+1)^{th} layer are stored, and said output pointer points to a fifth memory address of the scratchpad memory for storage of a result of the convolution operation for the (n+1)^{th}-layer therein.

10. The neural network accelerator of claim 7, further comprising:
a feature processing circuit that is configured to perform a fused operation of max pooling, batch normalization and binarization on a result of the convolution operation performed on the to-be-processed data and the n^{th}-layer kernel maps, so as to generate the n^{th}-layer output feature maps, wherein said feature processing circuit includes a number i of adders, a number i of binarization circuits, an i-input AND gate and a two-input XNOR gate that are coupled to perform the fused operation defined by:
$$y = {AND}_{i} ( sign ( {x}_{i} + {b}_{a} ) ) XNOR sign ( γ )$$
$$where sign ( x ) = \{ \begin{matrix}0 if x \geq 0 \\ 1 if x < 0\end{matrix}$$
where xᵢ represents inputs of the fused operation, which are results of the dot product operations of the convolution operation; y represents a result of the fused operation; γ represents a predetermined scaling factor, and bₐ represents a predetermined bias constant related to an estimated average and an estimated standard deviation of the results of the dot product operations of the convolution operation.

11. A scheduler circuit for use in a neural network accelerator that is electrically coupled to a scratchpad memory of a processor, the scratchpad memory storing to-be-processed data, and multiple kernel maps of a convolutional neural network (CNN) model, the neural network accelerator being configured to acquire the to-be-processed data and the kernel maps from the scratchpad memory so as to perform a neural network operation on the to-be-processed data based on the kernel maps,
said scheduler comprising multiple counters, each of which includes a register to store a counter value, a reset input terminal, a reset output terminal, a carry-in terminal, and a carry-out terminal;
wherein the counter values stored in said registers of said counters are related to memory addresses of the scratchpad memory where the to-be-processed data and the kernel maps are stored;
wherein each of said counters is configured to, upon receipt of an input trigger at said reset input terminal thereof, set the counter value to an initial value, set an output signal at said carry-out terminal to a disabling state, and generate an output trigger at said reset output terminal;
wherein each of said counters is configured to increment the counter value when an input signal at said carry-in terminal is in an enabling state;
wherein each of said counters is configured to set the output signal at said carry-out terminal to the enabling state when the counter value has reached a predetermined upper limit;
wherein each of said counters is configured to stop incrementing the counter value when the input signal at said carry-in terminal is in the disabling state;
wherein each of said counters is configured to generate the output trigger at said reset output terminal when the counter value has incremented to be overflowing from the predetermined upper limit to become the initial value;
wherein said counters have a tree-structured connection in terms of connections among said reset input terminals and said reset output terminals of said counters, wherein, for any two of said counters that have a parent-child relationship in the tree-structured connection, said reset output terminal of one of said counters that serves as a parent node is electrically coupled to said reset input terminal of the other one of said counters that serves as a child node; and
wherein said counters have a chain-structured connection in terms of connections among said carry-in terminals and said carry-out terminals of said counters, and the chain-structured connection is a post-order traversal of the tree-structured connection, wherein, for any two of said counters that are coupled together in series in the chain-structured connection, said carry-out terminal of one of said counters is electrically coupled to said carry-in terminal of the other one of said counters.

12. The scheduler circuit of claim 11, further comprising a pointer register unit that stores an input pointer, an output pointer and a kernel pointer, and said scheduler loads the to-be-processed data from the scratchpad memory based on said input pointer, loads the kernel maps from the scratchpad memory based on said kernel pointer, and stores a result of the convolution operation into the scratchpad memory based on said output pointer;
wherein, when the neural network accelerator performs the convolution operation for an n^{th} layer of the CNN model, where n is a positive integer,
the to-be-processed data is n^{th}-layer input data,
said input pointer points to a first memory address of the scratchpad memory where the n^{th}-layer input data is stored, said kernel pointer points to a second memory address of the scratchpad memory where n^{th}-layer kernel maps which are those of the kernel maps that correspond to the n^{th} layer are stored, and said output pointer points to a third memory address of the scratchpad memory to store n^{th}-layer output feature maps that are the result of the convolution operation for the n^{th}-layer;
wherein, when the neural network accelerator performs the convolution operation for an (n+1)^{th} layer of the CNN model, said input pointer points to the third memory address of the scratchpad memory and makes the n^{th}-layer output feature maps stored therein serve as the to-be-processed data for the (n+1)^{th} layer, said kernel pointer points to a fourth memory address of the scratchpad memory where (n+1)^{th}-layer kernel maps which are those of the kernel maps that correspond to the (n+1)^{th} layer are stored, and said output pointer points to a fifth memory address of the scratchpad memory for storage of a result of the convolution operation for the (n+1)^{th}-layer therein.
